(19) United States
(12) Patent Application Publication
(10) Pub. No.: US 2020/0305471 A1
(43) Pub. Date: Oct. 1, 2020

(54) METHODS AND COMPOSITIONS FOR IMPROVING THE TASTE OF DIET COLA SODAS AND OTHER BEVERAGES

(71) Applicant: Gregory AHARONIAN, Belmont, MA (US)

(72) Inventor: Gregory AHARONIAN, Belmont, MA (US)

(21) Appl. No.: 16/642,987

(22) PCT Filed: Aug. 30, 2018
(86) PCT No.: PCT/US2018/048703

§ 371 Date: Feb. 28, 2020

Related U.S. Application Data
(60) Provisional application No. 62/552,636, filed on Aug. 31, 2017.

(51) Int. Cl. A23L 2/60; A23L 2/56; A23L 27/00; A23G 1/48; A23G 1/56

(52) U.S. Cl. CPC A23L 2/60; A23L 2/56; A23G 1/56; A23G 1/48; A23L 27/88

(57) ABSTRACT

An improved diet cola beverage comprises ethyl benzoate (and/or methyl benzoate, propyl benzoate or benzyl benzoate). An improved diet cola beverage comprises an extract of the coca leaf. Such improved beverages can additionally comprise an artificial sweetener. The extract of coca leaf plant may be decocainized, and provided in either liquid or powder form. The ratio of diet cola beverage product and the extract of the coca leaf plant can be combined at a ratio by weight of approximately 22:1 to 44:1.

### RELATED APPLICATIONS

The present application claims the benefit of U.S. Provisional Patent Application No. 62/552,636 filed Aug. 31, 2017, the disclosure of which is incorporated herein by this reference in its entirety.

### TECHNICAL FIELD

This disclosure relates to beverage products, in particular to, but not limited to, improving the taste and/or aroma of artificially sweetened beverages, especially cola sodas.

### BACKGROUND

In recent years, beverage and food companies have come under government attack and suffered consumer defections, one reason being that their products have large amounts of (added) sugar, in an era when consumers are consuming much more sugar each day than is recommended by government and medical groups such as the American Heart Association. These recommendations are based on an increasing amount of science that links this excessive added sugar consumption to diabetes, obesity, heart disease, cancer and Alzheimer's disease (and indirectly lung cancer, since cigarettes are hard to smoke without adding a few grams of sugar to each cigarette)—diseases which governments annually spend trillions to improve public health.

For example, Coca-Cola uses over two million tons of sugar each year in the U.S. This added sugar in beverages is being demonized as a harmful, mildly addictive drug, especially high fructose corn syrup, which can cause non-alcoholic fatty liver disease. In 2016 and 2017, Coca-Cola was sued three times in the U.S. for its added-sugar products for allegedly harming public health. Coca-Cola's annual 10-K report, has their Risk Factor section start with a warning of the risk to profits from these health concerns about sugar, risks such as lawsuits.

In response, Coca-Cola, Pepsico and other beverage manufacturers have introduced artificially-sweetened sodas such as Diet Rite (the first in 1958), Tab, Diet Coke (introduced in 1982), Coca-Cola Zero, Coca-Cola Zero Sugar, and Diet Pepsi, replacing some or all of the sugar with sweetish chemicals such as aspartame, acesulfame, sucralose, saccharin and others. Unfortunately, some of these chemicals cause an unpleasant lingering after-taste, e.g., chemicals such as acesulfame with sulfur and potassium, and sucralose with chlorine. A natural sweetener, stevia, is unpleasant enough that it is still used with sugar, such as in CocaCola Life soda, for which a 12 ounce can of CocaCola Life contains 24 grams of sugar (and some stevia) as compared to regular CocaCola with 39 grams of sugar—about a 40% reduction.

The three biggest brands of cola sodas are Coca-Cola, Diet Coke and Pepsi—an extremely competitive space where these huge multinationals seize the slightest innovation to be competitive, constantly seeking any new additive such as stevia to gain an edge in a multi-year trillion dollar industry. In the United States, circa 2016, the Coca-Cola company annually sells about 4.5 billion liters of Coca-Cola, 2.3 billion liters of Diet Coke and 0.8 billion liters of Coke Zero. Because of the aftertaste due to the artificial sweeteners, beverages such as Diet Coke and Coca-Cola Zero and Diet Pepsi just don't taste enough like Coca-Cola to surpass them in sales. In blind taste tests, few, if any, consumers are fooled into thinking that Diet Coke is Coca-Cola.

Failure of Others: Despite hundreds of billions of dollars of sales of cola beverages each year, and spending hundreds of millions of dollars in research and development (e.g., Coca-Cola has six R&D centers around the world linked to External Technology and Assessment hubs), and stagnant sales (though still above $10 billion/year for all cola sodas in the U.S.), all those who are ‘skilled’ have failed to make drinking diet colas as pleasant an experience as sugary sodas, a failure that prevents diet colas from displacing, to a greater extent, sugary colas in terms of consumer sales (except where, e.g., sugary drinks are heavily taxed).

The failure to improve the experience of drinking artificially sweetened cola sodas is seen in a common response of someone drinking Diet Coke. At the beginning of the first mouthful, there is enough “Coca-Cola” taste and sweetness from the artificial sweeteners to create the sensation of a “regular Coca-Cola” experience. But then the unpleasantness due to the artificial sweeteners becomes more apparent, so that further drinking becomes less appealing. Further, the effects of the sweeteners linger to succeeding mouthfuls of Diet Coke, so that further mouthfuls don't provide more of a “regular Coca-Cola” experience. Most consumers finish the Diet Coke much because of their sunk costs, rather than that they truly enjoy the experience. Only by adding one or two more artificial sweeteners (such as with Coke Zero) can the taste be at least made sweeter, at the expense of the “coca-cola” taste.

### Difficulties in Using Artificial Sweeteners in Sodas

For decades, cola soda companies and others have tried to find any improved mixtures of artificial sweeteners that make their diet sodas less unpleasant. The competitive history of these companies guessing at a variety of mixtures over the decades is evidence of the failure to fully understand these sweeteners' biochemical effects. Diet Coke only uses aspartame (as does Diet Dr. Pepper), while Coca-Cola Zero and Coca-Cola Zero Sugar use both aspartame and acesulfame, as do Coca-Cola Vanilla Zero, Coca-Cola Cherry Zero, Diet Coke Lime and Coca-Cola Orange Fanta Zero. Jones' Zero Calorie Black Cherry Soda uses just sucralose, while Coca-Cola's Fresca Toronja uses sucralose and acesulfame, as do Diet Coke with Splenda, Monster Energy's Lo-Carb Energy drink (has 3 grams of sugar), Monster Energy's Energy Ultra Black (with 1 gram of erythritol) and Diet Shasta Grapefruit. One other difference between Diet Coke and Coca-Cola Zero is that Diet Coke uses citric acid, while Coca-Cola Zero uses sodium citrate (both chemicals acting as acidity regulators). Modern formulations of Coca-Cola's Tab use aspartame and saccharin. Diet Pepsi has gone from using saccharin to using aspartame (as does Diet Coke) to now using sucralose and acesulfame, with SodaStream Diet Cola Soda Mix also using sucralose and acesulfame. Diet A&W Root Beer uses aspartame and acesulfame, Diet IBC Root Beer uses aspartame and saccharin, while Cott Beverages' Stars & Stripes Root Beer uses aspartame and acesulfame while also still using 23 grams of sugars per 12 ounces. Many consumers in Latin America prefer sweeter versions of foods and beverages. For example, in the U.S., Diet Pepsi uses sucralose and acesulfame, but in Costa Rica, Diet Pepsi uses sucralose, acesulfame and aspartame.

The world's first diet cola, Royal Crown Diet Rite, launched in 1958, used saccharin and cyclamate, as did Coca-Cola's soon-to-follow competitive product, Tab. Cyclamate was designated as Generally Recognized As Safe (GRAS) by the U.S. FDA in 1958. However, based on now-discredited animal cancer studies funded by the sugar industry (financially threatened by a 1:10 combination of saccharin and cyclamate that had very little unpleasant aftertaste) the FDA removed cyclamate's GRAS designation in 1969, and banned its use in general-purpose foods. Today, though, most of the world's largest economies (such as Europe) approve the use of cyclamate in beverages, and filings have been made to the FDA to have the agency re-designate cyclamate as GRAS, based on scientific data. However, in the United States, the major soda companies have abandoned cyclamate and saccharin for these newer sweeteners, which have health concerns, e.g., aspartame, acesulfame and sucralose.

### Coke Zero Sugar U.S. versus Coke Zero Sugar Brazil

The difficulties that cola soda companies have in understanding and mastering combinations of artificial sweeteners is seen in a comparison of the composition of Coke Zero Sugar U.S. versus Coke Zero Sugar Brazil. In 2017, Coca-Cola introduced Coca-Cola Zero Sugar, a slightly “sweeter” reformulation of its Coca-Cola Zero, both of which use aspartame and acesulfame. However, in Brazil, Coca-Cola Zero Açúcar uses aspartame, acesulfame and cyclamate (Coca-Cola also uses cyclamate in its diet cola products in Germany), with little change in taste, raising the question as to why bother adding cyclamate. Clearly, after 60 years of using artificial sweeteners, cola soda companies have failed to create diet colas with no unpleasant aftertaste, let alone provide the full experience of drinking their sugar-based cola sodas. Another failure with artificial sweeteners can be seen with PepsiCo's U.S. Pat. No. 6,265,012, “Reduction of Lingering Sweet Aftertaste of Sucralose”, which added about 10 parts per million of gallontannin (it is not known if Diet Pepsi ever used this additive).

Indeed, in the summer of 2017, Coca-Cola announced a $1 million prize to the first person/group in the public to find a new natural sweetener for its cola beverages (beyond the use of the known, and patented, stevia and monk fruit). It is ‘obvious’ that those ‘skilled’ at Coca-Cola have failed to fully understand the “coca-cola” taste, since the company is only asking for a new sweetener, instead of also asking for new natural flavoring additives (also due in part to Coca-Cola and PepsiCo for a longtime NOT motivating inventors to discover new flavorings, since on their Web sites, the two companies forcefully state of everyone to NOT send them proposals involving new flavorings). For the near-trillion dollar soda industry, those highly ‘skilled’ expect' that the only way to improve diet sodas is to find a better sweetener.

### Difficulties in Using Flavorings to Improve Cola Sodas

Coca-Cola has greatly exploited for marketing purposes its “vaulted trade secret”—its secret flavoring ingredients. Which is probably their only formulation secret, since in a little-known U.S. Federal Court decision from 1983, Coca-Cola disclosed the exact composition of one of its Coca-Cola syrup and diet Coca-Cola syrup formulations except for the flavoring ingredients (see FIG. 1). What is left to discover are the exact amounts of flavoring ingredients. But for over 100 years, global research into Coca-Cola's flavoring ingredients has been almost non-existent. For example, to date, about 20,000 university theses and dissertations mention “Coca-Cola”. None include the data and embodiments for new flavoring ingredients disclosed herein.

Cola sodas have long been suspected to use small quantities of fruit oils, some of the fruits maybe including orange, lemon, lime, neroli, cinnamon and/or nutmeg. Two aromatic chemicals, limonene and cinnamaldehyde, and one aromatic family based on terpenes (including alpha-terpineol and gamma-terpinene) are all known to available in such fruit oils and also known by a few spectroscopic analyses to be present in cola sodas. The potential importance of two of these chemicals is signified in the two, if only two, patents from Coca-Cola and Pepsi dealing with these chemicals: U.S. Pat. No. 5,220,105, “Process for purifying d-limonene” (Coca-Cola, which does not mention sodas) and U.S. Pat. No. 8,431,178, “Increasing the concentration of terpene compounds in liquid” (PepsiCo). FIG. 2 is table of some plants that can be the basis of essential oils used food preservation, flavor and safety (many of which include the terpineols and limonene, as indicated). Despite the many possible flavorings from mixtures of these essential oils, and other essential oils, all those ‘skilled’ have failed to discover any such mixtures of such essential oils to improve the tastes and aromas of diet cola sodas. It is unknown if the cola soda companies still use extracts of the fruit oils, or just the main chemicals in these extracts.

While the original Coca-Cola soda developed by John “Doc” Pemberton and Asa Candler made use of extracts of the coca leaf and kola nut—its Merchandise No. 5 ingredient, over time the company eliminated one, if not both (part of the trade secret). The kola nut extract probably has been eliminated because it is more cost effective to use industrial caffeine. The coca leaf extract probably has been eliminated because Coca-Cola doesn't find it useful anymore as part of their sodas' taste and/or aroma. When Coca-Cola launched its infamous “New Coke” in 1985, it unexpectedly didn't use Merchandise No. 5 (kola and coca) in its New Coke, and unexepected there is no evidence that Coca-Cola ever used Merchandise No. 5 in its diet cola sodas. A reasonable assumption is that when Coca-Cola abandoned its New Coke three months later (a highly competitive battle with Pepsi involving just a 1% change in the sugar content of Coca-Cola sodas), and relaunched its “Classic” Coke, that the company stopped using Merchandise No. 5 in that product as well. And it is a fact that PepsiCo has never discovered any commercial use of coca leaf extracts in its products.

Another failure of those ‘skilled’ is their inability to use commercial cola-soda flavorings to make the taste and/or aroma of diet cola sodas more like that of sugary cola sodas. For decades, companies such as International Flavor & Fragrance have sold cola flavorings. But none of these flavorings have motivated discovery of a diet cola soda that is more close in taste and/or aroma to non-diet cola sodas. FIG. 3 is a list of flavor additives for some food products from U.S. Pat. No. 4,404,184, titled “Flavoring with methyl-thio-2-methyl-2-pentenonate”, none apparently of use in improving cola sodas, with or without methyl-thio-2-methyl-2-pentenonate.

Another failure of those ‘skilled’ is their inability to use of components of Coca-Cola and cola flavorings to make diet colas taste more like the taste of Coca-Cola soda. Vanilla flavor was one of the original ingredients of Coca-Cola (Merchandise No. 8). But vanilla is a powerful flavoring that often overwhelms the base taste of a beverage. This can be seen, for example, Coca-Cola's Vanilla Zero cola soda, the vanilla overwhelming the “Coca-Cola” flavor. The failure of Coca-Cola's Diet Coke Lime is that it is little more than the unpleasant taste of Diet Coke with the tartness of lime. Neither have proven to be popular cola sodas. Diet Pepsi seems to be more of a failure—a January 2018 report by Morning Consult on views of unfavorable brands found that the third most unfavorable brand for Democrats and Republicans (39% viewing unfavorably—for Independents, 45%) is Diet Pepsi.

Another failure of those ‘skilled’ is the lack of innovation by the giant ‘extraordinarily’ skilled' corporations of the cola soda industry. Most of Coca-Cola's recent patents with the word “taste” in the claims are just for patents on new sweeteners for Coca-Cola beverages (for example, U.S. Pat. No. 9,173,425, “High-potency sweetener composition with vitamin and compositions sweetened therewith”). Coca-Cola has moved away from the pure “Coca-Cola” taste with some of its diet cola sodas, such as Diet Cherry Coke, Diet Vanilla Coke, Diet Coke with Lime, and Diet Coke with Citrus Zest (Coca-Cola Company did much the same with its first diet Cola, Tab, with beverages such as Tab Lemon-Lime, and Tab Black Cherry), and in 2018, Diet Coke with exotic fruits such as mango. Pepsi has its Pepsi Fire cinnamon flavored cola.

Since the introduction of diet colas in 1950s, the cola beverage industry with its multi-hundred-billion dollars per year in sales, has failed to satisfy the consumer need for a really “Coca Cola”-tasting cola soda beverage free of mildly addictive, harmful sugar, a failure magnified by the hundreds of millions of dollars spent on beverage research by ‘skilled’ experts to improve cola sodas.

In light of hundreds of billions of dollars of profits and expenditures across the decades by Coca-Cola (and PepsiCo), one meaning of utterly ‘not obvious’ is any use of flavorings, aromatics and/or sweeteners to improve the taste and/or aroma of Diet Coke and Coke Zero that have NOT been discovered by Coca-Cola (and PepsiCo), two companies with many highly-paid beverage scientists ‘extraordinarily’ skilled' in whatever ‘arts’.

Artificial Sweeteners. For example, in 1931 scientists identified the glycosides in stevia leaves that make stevia extracts to be a calorie-free natural sweetener. So ‘obvious’ to use in cola sodas that it required 70 years for Coca-Cola and PepsiCo to start using stevia extracts in their cola sodas. Similarly, in 1937, a scientist discovered an artificial sweetener, sodium cyclamate, 58 years after saccharin was discovered (saccharin used by Coca-Cola around 1901 to adulterate Coca-Cola soda to lessen the need for sugar). So ‘obvious’ to use in cola sodas to eliminate some-to-all of the sugar that it is 20 years before the first diet cola sodas are launched, NOT by Coca-Cola nor PepsiCo, but rather by the Kirsch brothers in 1952 (their “No-Cal” ginger ale) and Royal Crown in 1961 (its Diet Rite Cola using cyclamate and saccharin).

Terpenes. As far back as the 1980s, a tiny number of scientists started to identify some of the flavoring chemicals in cola sodas. For example, two terpenes, gamma-terpinene and limonene, were identified in 1984 in cola sodas in a paper, “Studies on turpentine-like off-odor in cola” (Journal of Food Science, March 1984). In 1991, Coca-Cola was awarded U.S. Pat. No. 5,220,105, “Process for purifying d-limonene”. In 2010, PepsiCo was awarded U.S. Pat. No. 8,431,178, “Increasing the concentration of terpene compounds in liquids”. Despite the huge size of the cola soda industry (over a hundred billion dollars a year in sales), it has not been ‘obvious’ for many ‘extraordinarily’ skilled' in whatever ‘arts’ to discuss these chemicals. In 2006, Wiley published “Terpenes—Flavors, Fragances, Pharmaca and Pheromones” by Eberhard Breitmaier, a 200-page terpene-chemistry-rich book that nowhere mentions the use of terpenes as flavorings in cola sodas. In 2003, the Royal Society of Chemistry published “A Fragrant Introduction to Terpenoid Chemistry” by Charles Sell, a 400-page terpene-chemistry-rich book, that nowhere mentions terpenes as flavorings in cola sodas. In 2006, Blackwell Publishing published “Carbonated Soft Drinks—Formulation and Manufacture” by David Steen and Philip Ashurst, a 340-page carbonated-beverage-rich book, that nowhere discusses terpene chemistry as it affects carbonated beverage (though a table of ingredients for a peach flavoring on page 67 includes terpenes such as geraniol and terpineol acetate, and a pineapple flavoring on page 83 includes “terpeneless” lemon oil). Despite mentioning GC/MS analysis, it was not ‘obvious’ in Steen/Ashurst's book to includes GC/MS analyses of the two most popular carbonated beverages in the world, Coke and Pepsi. In 2016, WileyBlackwell published “Chemistry and Technology of Soft Drinks and Fruit Juices” by the same Philip Ashurst, a 420-page carbonated-beverage-rich book. The discussion of “Flavourings” on pages 102 to 108 nowhere discussed flavoring chemicals (except the peach flavoring data from the 2006 book), and despite having five HPLC graphs of sugar content of carbonated beverages and fruit juices, it was not ‘obvious’ to have any GC/MS graphs for Coke and Pepsi focusing on known terpenes present such as gamma-terpinene and limonene. These are all failures of those ‘skilled’ in an industry with trillion of dollars of sales over the decades, and billions of dollars spent on research and development.

### Soda Terpenes as Unrecognized Hormone Disruptors

In 2018, scientists at the U.S. National Institutes of Health, lead by J. Tyler Ramsey, published data confirming a link between regular exposure to externally-applied essential oils (in particular, lavender or tea tree oils) and abnormal breast growth in young boys (pre-pubertal gynecomastia). The scientists determined that at least eight chemicals in these oils probably contributed to the abnormal breast growth: eucalyptol, 4-terpineol, limonene, alpha-terpineol, linalyl acetate, linalool, alpha-terpinene and gamma-terpinene. What no one ‘skilled’ in any ‘art’ realized upon the publishing of this data, such as the FDA, is that one of the largest sources of internal exposure for billions to these potential hormone disruptors is due to their consumption of soda beverages, in particular, cola soda beverages. This complete failure of those ‘skilled’ prevents the realization that alternative flavoring formulations may be needed for soda beverages, alternative formulations that rely less on terpenes and related chemicals, if further research proves their potential as hormone disruptors on more people than just young boys.

Coca Leaf Extracts. For over a century, the business world has speculated about Coca-Cola's use of extracts of the coca leaf. As a trade secret, Coca-Cola has steadfastly refused to publicly comment on its past use of the coca leaf, beyond the fact that the original Coca-Cola used coca leaf extracts, and that, yes, Coca-Cola obtains its de-cocainized leaves from the Stepan Company of New Jersey, which has the only DEA license to import coca leaves from ENACO in Peru. Yet over these 100+years, it has not occurred to anyone, especially Pepsi with its billions of dollars and ‘skilled’ chemists, to spend a few dollars to call ENACO at (51) 8458-2027, and order de-cocainized coca leaf extract to be shipped to their facilities for use in their sodas. Especially for extremely competitive Pepsi, always in second place in sales to CocaCola for decades, this is a massive failure of those ‘skilled’. For Coca-Cola it is a manufacturing failure, but a trade-secret-war success, for it to not purchase de-cocainized coca leaf extract directly from ENACO, so it can maintain the fiction of secrecy created with ‘needing’ Stepan, contributing to Pepsi's failure. But Coca-Cola has failed as well, despite employing ‘extraordinarily’ skilled' scientists, in one of its few technology admissions, when it admitted that it stopped using coca-leaf extracts when it launched its diet colas, and in another failure, more than likely stopped using coca leaf extracts in its sugary colas after the New Coke marketing failure in 1985.

All of these failures of the ‘skilled’ to do the ‘obvious’—call ENACO to order and have shipped coca leaf extracts—especially in the past four years, is greatly lamented by ENACO, which has struggled for decades to create new, legal markets for the coca farmers of its country.

Ethyl benzoate. Some of the embodiments disclosed herein use an aromatic ester, ethyl benzoate (C₉H₁₀O₂). Ethyl benzoate is almost entirely unknown as a taste and/or aroma modifier for beverages and foods. The 860-page industry classic, “Source Book of Flavors” by Henry Heath (Avi Publishing, 1981), nowhere mentions ethyl benzoate. The 620-page industry classic, “Dictionary of Flavors” by Dolf De Rovira (Wiley Blackwell, 3^{rd} edition, 2017), has no entry for ethyl benzoate. The 895-page reference, “Essential Oils in Food Preservation, Flavor and Safety” edited by Victor Preedy (Academic Press, 2016), with analyses of 83 plant oils, nowhere mentions ethyl benzoate. The Standards Database of the International Fragrance Association has no entry for ethyl benzoate. A main industry reference, “Carbonated Soft Drinks: Formulation and Manufacture” by David Steen and Philip Ashurst (Blackwell, 2006), nowhere mention of ethyl benzoate. The query (SPEC/“ethyl benzoate” AND SPEC/“diet soda”) across the 10,000,000+ patents of the USPTO Patent Full Text and Image Database returns no entries, nor are there any entries returned for this query across the Patent Application database. The queries (“ethyl benzoate” and “diet beverage/soda”) across the 28 million entries of the PubMed database returns no entries. The query (“ethyl benzoate” and “soda or beverage”) across the extensive database of the American Chemical Society returns no entries. This is a complete failure of those ‘skilled’ with billions of dollars for R&D in whatever ‘arts’.

### SUMMARY

In one example embodiment, a diet cola beverage with an improved taste and/or aroma is disclosed comprising a diet cola beverage product containing an extract of the coca leaf plant, and optionally, an additional artificial sweetener. The improved diet cola beverage can also include an extract of the coca leaf where the extract of the coca leaf plant is de-cocainized, where the extract is in liquid and/or powder form. The improved diet cola beverage may also include a formulation where the diet cola beverage product and the extract of the coca leaf plans are combined at a ratio by weight of approximately 22:1 to 44:1.

In another example embodiment, a diet cola syrup with an improved taste and/or aroma is disclosed comprising a diet cola syrup containing an extract of the coca leaf plant, and optionally, an additional artificial sweetener. The improved diet cola syrup can also include an extract of the coca leaf where the extract of the coca leaf plant is decocainized, where the extract is in liquid and/or powder form. The improved diet cola syrup may also include a formulation where the diet cola syrup and the extract of the coca leaf plans are combined at a ratio by weight of approximately 22:1 to 44:1.

In other example embodiments, a diet cola beverage or syrup may also include an extract of the coca leaf plant that comprises one or more ingredients selected from ethyl benzoate, cinnamoylcocaine, hygrine, cuscohygrine, benzoic acid, trans-cinnamic acid, ethyl cinnamate, cinnamaldehyde, ethyl vanillate, caffeic acid, and eudesmic acid or a combination thereof

### BRIEF DESCRIPTION OF THE DRAWINGS

FIG. 1 depicts much of the chemical composition of Coca-Cola and Diet Coke soda circa 1983.

FIG. 2 depicts a table of essential plant oils.

FIG. 3 is a list of flavor additives used in some food products.

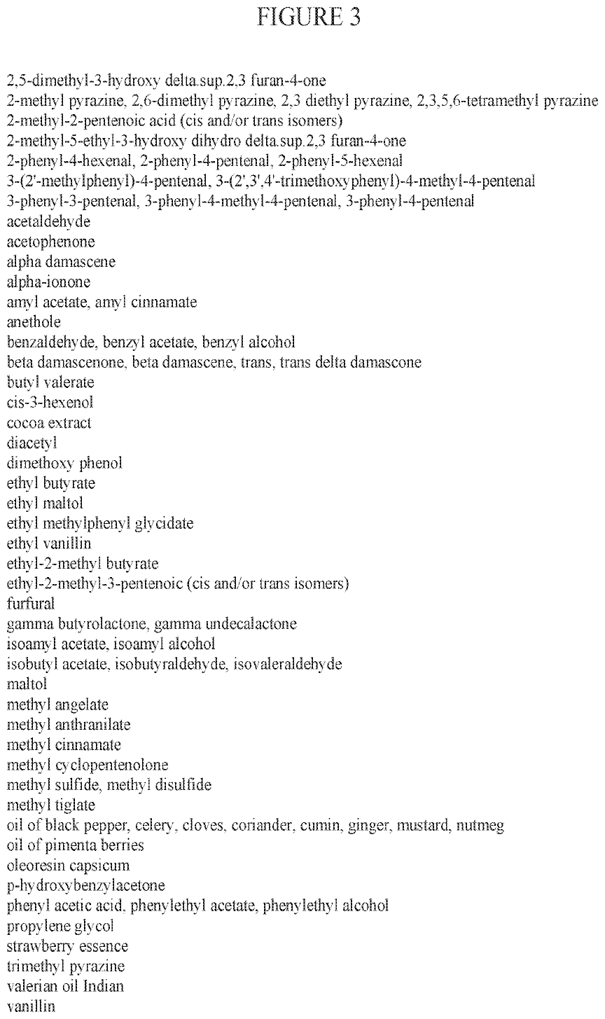

FIG. 4 depicts a GCMS analysis of ENACO ERC-A20 coca leaf liquid extract.

FIG. 5 depicts a GCMS analysis of Coca-Cola soda.

FIG. 6 depicts an alignment of a GCMS analysis of Coca-Cola soda and ENACO coca leaf extract.

FIG. 7 depicts a GCMS analysis of Diet Coke soda.

FIG. 8 depicts GCMS analyses of Coca-Cola and Diet Coke sodas.

FIG. 9 depicts GCMS analyses of Pepsi cola soda and coca leaf extract.

FIG. 10 depicts a formulation for a Coca-Cola flavoring.

### DETAILED DESCRIPTION OF ILLUSTRATIVE EMBODIMENTS

Introduction to The Embodiments Disclosed Herein

To provide enabling context for some of the embodiments disclosed herein, a simple formulation is first described here (further enabled as Exemplary Embodiment #1 below). Pour into a cup about 7.5 ounces of a Diet Coke that uses just aspartame. Mix in about one teaspoon of decocainized liquid coca leaf extract, both liquids at room temperature. Drinking the resulting beverage ends with a more pleasant taste and/or aroma as opposed to the taste and/or aroma that occurs solely with existing diet colas. In the United States, use of de-cocainized coca leaf extracts is Generally Recognized As Safe (GRAS) by the U.S. Food and Drug Administration (see the little-known coca entry of 21 U.S. Code of Federal Regulations 182.20).

For the embodiments disclosed herein, the signifier “aroma” is used in preference to its synonyms: smell and odor (which have negative connotations), and scent (which has perfume connotations). The signifier “taste” is mostly used herein, and to a lesser extent, “flavor”, which often signifies a specific “taste”. One criteria for determining an improved food product is consumer choice—e.g., in a blind taste test between two cola beverages, which beverage's aroma/smell/odor/scent/taste/flavor do the majority of consumers choose (“majority” reflecting that each consumer has differing aroma/smell/odor/scent/taste/flavor preferences—for example, many Colombians enjoy mondongo).

Taste and aroma are not separate sensory experiences. For example, when many people are afflicted with the common cold, and have stuffy noses, they can lose some or all of the taste of foods. This is attributed to the odor sensors in the nose being blocked. Also, when many people eat foods, they can have a time dependent sensory experience, as the (chewed) food travels to the back of the mouth and some of the aromas enter the back of the nasal cavity, due to retronasal smell (versus orthonasal smell due to aromas entering the front of the nasal cavity, for example, when you sniff a rose). Thus, in many of the embodiments disclosed herein, the term “taste and/or aroma” is used. Also, in many of the Exemplary Embodiments that follows, statements in changes in taste and/or aroma are based on the opinions of a few people. Not all people drinking the embodiments disclosed herein will experience the same improvements in taste and/or aroma.

### Parameters for Exemplary Embodiments

The density of Diet Coke is approximately the same as water at 1.0 gm/ml, while Coca-Cola soda with its many grams of sugar has a density of about 1.1 gm/ml. The density of liquid coca leaf extracts is approximately the same as the density of water, which is 1.0 gram/milliliter (gm/ml) (a cup of brewed coca tea with 250 grams of water can contain tens of milligrams of the chemicals in coca leaves—these tens of milligrams added to a few grams of water to prepare an extract do not appreciably change the density of water).

For many of the exemplary embodiments that follow, the term ‘soda’ is used, for example, ‘diet soda’, ‘diet cola soda’, ‘soda beverage’, etc. The use of ‘soda’ refers to any carbonated beverage, that is, a liquid that contains bubbles of carbon dioxide. This includes ‘club soda’, that is, carbonated water with added minerals and dissolved solids; and ‘seltzer’ which is club soda minus the added minerals and dissolved solids. Both can be flavored, becoming more like the more popular sodas (or soda “pop”, a regional term in the United States, another regional term being “tonic”) with the addition of sweeteners. Carbonation levels range from 2 to 4 grams per liter for beers, around 6 grams per liter for sodas and seltzers, and around 8 grams per liter for champagne.

For the exemplary embodiments that follow, the examples are performed with all liquids at room temperature. Sodas typically taste more flavorful at lower temperatures (sodas retain carbonation better at lower temperatures, which creates a better taste for many people). Any improvements in taste and/or aroma resulting from any of the following embodiments at room temperature are similar, if not more pleasant, at lower temperatures down to freezing. Tastes and/or aromas can also vary due to the use of soda container: glass, plastic or metal. There are many who think that cola sodas taste best when consumed from glass bottles. For many of the exemplary embodiments disclosed herein, Bodum Pavina Coffee Mugs, double-wall insulated glass mugs, 8 ounce size, are used.

While Diet Coke is used in many of the following examples that disclose how to improve the taste and/or aroma of diet colas, the embodiments can be useful, e.g., to improving any other diet cola soda or diet root beer or diet soda (typically with multiple artificial sweeteners), or to improve non-Coca-Cola cola sodas to have their tastes and/or aromas provide an experience more like that of Coca-Cola sodas.

### Exemplary Embodiment #1

One embodiment of an improved diet cola beverage product is understood with the following exemplary method and resulting exemplary article of manufacture. Pour 7.5 ounces of Diet Coke or Coke Zero or Coke Zero Sugar (about 220 grams—about 222 milliliters) into a container such as a cup. Mix in any of one teaspoon of liquid coca leaf extract (about 5.0 grams), one half tablespoon of coca leaf extract (about 7.5 grams) or two teaspoons of coca leaf extract (about 10.0 grams), for example, the ERC-A20 liquid coca extract available from ENACO (Lima, Peru—their first extracts sold circa 2006). The resulting beverage, when consumed, ends with a more pleasant taste and/or aroma as opposed to the taste and/or aroma than is experienced with existing diet colas. Any coca leaf extract with similar chemical components to ERC-A20 can be used—coca leaf extracts discussed below.

Adding more than two teaspoons of coca leaf extract does not significantly improve the “Coca-Cola” taste and/or aroma for many people, and can make the resulting beverage have more of a leafy taste and/or aroma. The number of teaspoons of coca leaf extract added per 222 milliliters (and similar ratios for larger quantities) can be chosen to satisfy consumer preferences, for example, to create a more “coca leaf tasting” cola soda. The current formulation of ERC-A20 liquid coca leaf extract has an oil base, which can impart an “oily” taste. This “oily” taste can be minimized, by increasing the concentration of the coca leaf extract in the oil base, e.g., by a factor of ten, or by using an oil-free synthetic extract (e.g., to be added to syrup emulsions). Then, where one to two teaspoons are used in some of the Exemplary Embodiments disclosed herein, only one-tenth to two-tenths of a teaspoon need to be added.

This example illustrates one exemplary ratio of diet cola soda to coca leaf extract, that of approximately 22:1 (220 grams/10.0 grams) to approximately 44:1 (220 grams/5.0 grams). Thus, in some embodiments, 22 to 44 tons of diet cola soda can be treated with 1 ton of ERC-A20 coca leaf extract. The ratio depends entirely on the final taste desired by the manufacturer of the diet cola soda.

Although the formulation in this embodiment describes the use of fluid extract of coca leaves, similar results can be obtained using a powder form of an extract of coca leaves. In a variant of Exemplary Embodiment #1, about one-tenth of a teaspoon of the powder form of ERC-ARC extract is used instead of one teaspoon of the liquid extract. A similar improvement in taste and/or results. For all of the Exemplary Embodiments disclosed herein, wherever about one teaspoon of liquid ENACO coca leaf extract is used, about one-tenth teaspoon of powdered ENACO coca leaf extract can be substituted (or equivalent coca leaf extracts).

The cost of this additional ingredient is economical for the soda industry. The ERC-A20 liquid coca leaf extract sold in small volumes by ENACO costs approximately $9 for 1 kilogram (circa March 2017). Thus, 7.5 grams of extract, to be added to 220 grams of a diet cola, costs about 8.5 cents. Large scale production of coca leaf extract can bring this price down to about 3 to 4 cents, a reasonable cost to add to the price of current diet colas (typical retail price is $1.00 in the U.S.) to improve their taste and/or aroma to be more like that of sugary cola sodas. And at no extra cost, using coca leaf extract adds multiple minerals and vitamins, found in the coca leaf, to the diet beverage.

### Exemplary Embodiment #2

Another embodiment of an improved diet cola beverage product mixes ERC-A20 coca leaf extract with a diet cola syrup. The ratio scales (i.e., more extract is needed), for example, respectively, 4.4:1 to 8.8:1, if the coca leaf extract (much more concentrated) is added to the diet cola syrup, where the syrup is later mixed with carbonated water to produce a soda beverage (cola syrups are typically diluted with soda water by a factor of approximately 5). For example, one can mix 220 grams of syrup with 38 grams of ERC-A20 extract, though in practice, one can mix 220 grams of syrup, for example, with about 1 gram of distillate of 38 grams of ERC-A20 extract where the distillation removes much of the water. Some suppliers of cola syrup include the following companies: Coca-Cola, PepsiCo, Sodastream (acquired by PepsiCo in 2018), Carnival King (their syrup is used for making cola slush), and RC Cola.

### Exemplary Embodiment #3

Another embodiment of an improved diet cola beverage product mixes ERC-A20 coca leaf extract with Diet Pepsi soda (with similar ratio adjustments for Diet Pepsi syrup). Many perceive Diet Pepsi to be “sweeter” than Diet Coke, with less of an aftertaste to many. Despite this apparent consumer taste preference, Diet Coke has higher sales volume (maybe Diet Pepsi being sweeter is less of a consumer preference than having more ‘coca cola’ taste). While a Diet Coke with an improved taste and/or aroma can be prepared by mixing 220 grams of Diet Coke with 1 teaspoon of coca leaf extract, a Diet Pepsi with an improved taste and/or aroma can be prepared by mixing 220 grams of Diet Pepsi with 0.5 (one-half) teaspoon of coca leaf extract. Another embodiment comprises 220 grams of a less-sweet Diet Pepsi soda and about one-half to one teaspoon of ERC-A20 coca leaf extract.

### Exemplary Embodiment #4

For some of the embodiments disclosed herein, mixtures of coca leaf extracts and diet soda beverages (and their syrups), of which their sugary versions have a ‘plant-ish’ taste (e.g., root beer) or ‘cough-syrupy’ taste (Dr. Pepper), are prepared with any of a variety of formulations of such diet soda beverages of the type available circa the year 2017, such as Diet A&W Root Beer, IBC Diet Root Beer and Dr. Pepper. To some people, diet root beers and diet Dr. Pepper taste ‘less unpleasant’ than diet colas, as compared to their sugary versions, due in part that to many people, root beer soda and Dr. Pepper already taste a bit ‘weird’.

One such embodiment comprises mixing 240 milliliters of diet root beer soda with about 0.5 (one-half) teaspoon of ERC-A20 coca leaf extract, that is, mixing approximately half as much coca leaf extract with a diet root beer soda, as opposed to about one or more teaspoons of coca leaf extract to a diet cola soda. Less of an improvement in taste and/or aroma is experienced with the root beer/coca extract mixture, than with the improvement in taste and/or aroma experienced with the diet cola/coca extract mixture.

### Sodium Cyclamate and Other Artificial Sweeteners

Other embodiments disclosed herein can comprise any of these diet beverages (and their syrups) where artificial sweeteners such aspartame and acesulfame are replaced or augmented by other artificial sweeteners, for example, combinations of sodium cyclamate and saccharin (for example, adding a combination of approximately 10 parts of sodium cyclamate and 1 part of saccharin, a combination which is known to mask the aftertastes of the two artificial sweeteners).

In some embodiments disclosed herein, diet root beers with added coca leaf extract can have artificial sweetener added (or an alternative to an existing artificial sweetener) using a combination or sodium cyclamate and saccharin. Extracts of coca leaf are compatible with food products that can use sodium cyclamate and saccharin as an alternative or complementary artificial sweetener. Since little additional sweetener needs to be added, a sugar alcohol such as xylitol can be used.

In some embodiments disclosed herein, low sugar sodas are made by adding sugar and coca leaf extract to the diet sodas, but with less sugar used than in the regular sodas. For example, one or a few 3.5-to-5 grams bags of sugar can be added with the leaf extract to Diet Coke (versus 39 grams in a can of Coca-Cola). Note: many ‘sugar-free’ artificial sweeteners contain sugar. The FDA allows a packet of artificial sweetener to be labeled ‘sugar-free’ if it contains less than 0.5 grams of sugar, which the labels typically obscure by calling the sugar ‘dextrose’, which is just d-glucose typically from corn syrup. A gram of sugar has 4 calories, and the FDA allows any food product with less than 5 calories per amount to be labeled “calorie free” or “zero calories” (21 CFR 101.60). Diabetics are not amused.

### Exemplary Embodiment #5

Another embodiment disclosed herein comprises 220 milliliters of Diet Coke, one teaspoon of ERC-A20 coca leaf extract, and up to about one bag of mostly sugar-free Sugar Twin artificial sweetener (one bag weighs about 0.8 grams—a bit less than a quarter of a teaspoon, produced by B&G Foods North America, and is 32% by weight sodium cyclamate—C₆H₁₂NHaO₃S, the rest being d-glucose [i.e, sugar] and silicon dioxide [i.e., sand]) or its equivalents. The resulting beverage is quite sweet while only requiring about 0.4 grams of sugar, as opposed to the 40 or so grams in sugary sodas—a 99% reduction. A pleasant but less sweeter beverage is obtained by only adding an eighth of a teaspoon of the Sugar twin. Alternatively, one bag of mostly sugar-free, stevia-based Nevella sweetener (one bag weighs 1.0 grams, produced by Heartland Food Products, which is 3% by weight of stevia extract, the rest being d-glucose). Alternatively, a few drops of a pure stevia extract, such as Natuvia (a combination of water, stevia extract, sodium benzoate, potassium sorbate, and malic acid) can be added, though purer stevia extracts tend to have an unpleasant taste and detract somewhat from the increased pleasantness due to the coca leaf extract, unless the extracts have more, or consist entirely of, rebaudioside A, which is the least unpleasant and has less after taste than the other glycosides in the stevia leaves. When granular artificial sweeteners are mixed into a carbonated beverage, it can foam due to nucleation, causing a loss of some carbon dioxide. To compensate, a soda or syrup can be manufactured with higher levels of carbon dioxide before the sodium cyclamate is added, or a liquid solution, with sodium cyclamate dissolved, can be added to the syrup. In some taste tests, ERC-A20 coca leaf extracts and/or sodium cyclamate added to Diet Coke (a total of 2 artificial sweeteners) has a taste and/or aroma more preferred than that of coca leaf extracts and/or sodium cyclamate added to Coca-Cola Zero (with 3 artificial sweeteners).

### Exemplary Embodiment #6

Another exemplary embodiment of the inventions disclosed herein comprises 220 milliliters of Diet Coke, and up to about one bag of mostly sugar-free Sugar Twin artificial sweetener (one bag weighs 0.8 grams, produced by B&G Foods North America, and is 32% by weight sodium cyclamate, the rest being dextrose and silicon dioxide)—that is, no coca leaf extract is used. While this produces a sweeter Diet Coke, sodium cyclamate's lack of an aroma results in a sweeter Diet Coke with an overall taste and aroma similar to that of other multiple-sweetener diet colas such as Diet Pepsi.

### Exemplary Embodiment #7

To the combination of Diet Coke, coca leaf extract and Sugar Twin as disclosed in Exemplary Embodiment #5, three drops of liquid Sweet'nLow are added (manufactured by Cumberland Packing), which only has the artificial sweetener saccharin. While this makes the resulting beverage a bit sweeter, the use of saccharin also reduces some of the lingering unpleasant aftertaste experienced due to the other artificial sweeteners present. An artificial sweetener from Brazil, Zero-Cal (produced by Cosmed Indústria de Cosméticos e Medicamentos in Goiânia) is a mix of sodium cyclamate and sodium saccharin (ratio not on the label), and sorbitol (one of the sugar alcohols, being about 60% as sweet as sucrose). It has little of the unpleasant taste associated with artificial sweeteners, while its taste can linger for less time. Zero-Cal and its equivalents can be used in the embodiments disclosed herein.

Exemplary Embodiment #7 is the basis of embodiments of other improved diet cola sodas, as follows. Prepare a diet cola beverage or syrup that has no artificial sweeteners such as aspartame, which is the sole artificial sweetener in present-day Diet Coke soda. Then add coca leaf extracts according to many of the embodiments disclosed herein. Then add an artificial sweetener that has about a 10:1 ratio of cyclamate/saccharin (with or without a low amount of a sugar alcohol, for example, a variant of the Brazilian Zero-Cal which has a about a 10:1 ratio of cyclamate/saccharin), adding more of this artificial sweetener than is disclosed used in Exemplary Embodiment #7, to achieve similar levels of sweetness to products such as Diet Coke while eliminating one source of unpleasant taste (such as aspartame). This is much equivalent to adding coca leaf extract to the original version of Tab soda introduced by Coca-Cola in 1963 some 55 years ago.

### Exemplary Embodiment #8

In embodiments, that use Sugar Twin or its equivalents, up to about one bag of Sweetwell artificial sweetener can be used instead. Sweetwell is a combination of polydextrose (a glucose polymer), isomalt (a sugar alcohol), dextrin, inulin (a collection of fructose polymers), fructooligosaccharide (derived from inulin) and sucralose. In other embodiments, a gram or so of xylitol (or other sugar alcohol) can be used.

### Exemplary Embodiment #9

Another embodiment disclosed herein comprises 220 milliliters of Diet Coke (minus acesulfame), plus about one teaspoon of ERC-A20 coca leaf extract, and up to 3 grams of a combination of approximately 10 parts of sodium cyclamate and 1 part of saccharin (or combinations of other artificial sweeteners such as xylitol, sorbitol, maltitol and/or erythritol), and/or with some sugar.

### Exemplary Embodiment #10

Around the world, many companies sell their versions of cola sodas with a similar taste and/or aroma to Coca-Cola, all attempting to recreate the Coca-Cola soda, but none doing so exactly. One of the closest-tasting cola sodas is Pepsi, which many experience as being sweeter than Coca-Cola, maybe to overcompensate for its lesser “cola” taste (335 milliliter Pepsi has 41 grams of sugar, while 335 milliliters of Coca-Cola has 39 grams of sugar). Another embodiment is where a company such as Pepsi produces a new cola, where the amount of sugar in their existing products are decreased and some coca leaf extract added, for example, using less than a half-teaspoon of extract with 220 milliliters of a non-Coca-Cola soda, and less than 25 grams of sugar.

### Exemplary Embodiment #11

Another embodiment of the inventions disclosed herein comprises 220 milliliters of Diet Coke, and one teaspoon of coca leaf extract, and one to two bags (5 to 10 grams) of sugar. The result is a more pleasant tasting Diet Coke soda. This embodiment is of commercial utility in that in the past, cola soda companies have (unsuccessfully) marketed what are basically 50%-of-the-sugar cola sodas, such as Coca-Cola C2 (half the sugar, about 20 grams, and three artificial sweeteners) or Coca-Cola Life and Pepsi True (half the sugar, plus stevia), the consumer apathy due in part to a 50% reduction in sugar being of little health value. But with this embodiment, cola sodas with about a 75% reduction in sugar can be manufactured. A reduction in sugar by 99% can be achieved with some additional artificial sweetener, as seen in Exemplary Embodiment #5.

### Non-Degradation of Added Coca Leaf Extract

One-half tablespoon of ENACO ERC-A20 extract was added to plastic bottles containing 355 milliliters of Diet Coke, and gently mixed, and then stored at room temperature. One bottle was sampled at 60 days, and there was no noticeable difference in taste and aroma. Other bottles were sampled at 90 and 120 days, and again, there was little noticeable difference in taste and aroma. In all cases, there is no noticeable difference in the coloring of the Diet Coke, nor is any clouding or sedimentation observed. Thus, the commercial use of coca leaf extract in cola sodas will not negatively affect the tastes and aromas of the improved sodas by being in the acidic environment of bottled sodas for the typical short-to-long term time periods experienced by bottled sodas stored on shelves at retail establishments.

### Additional Flavorings

All of these embodiments can further comprise additional flavorings to create drinks with similarly pleasant tastes and aromas. Two additional flavorings, in small amounts, are vanilla and cinnamon. In the above embodiments, quantities of vanilla and/or cinnamon of approximately less than 1/128th (one one-hundred-twenty-eighth) of a teaspoon can be added to mixtures of diet colas and coca leaf extracts without interfering with the “cola” taste and aroma.

### Coca Extract Chemistry

In some exemplary embodiments, the coca leaf extract is derived from at least one member of the plant genus Erythroxylum (“E.”). In some embodiments, the coca leaf extract is derived from at least one member selected from the group comprising E. coca (much grown in Bolivia and Peru), E. novogranatense var. truxillense (Trujillo, much grown in Peru, bought by Coca-Cola), and E. novogranatense var. novogranatense (much grown in Colombia). The E. coca and E. novogranatense are traditional sources for coca teas consumed in South America, but other coca varieties can be used as well whose extracts have similar chemical compositions to the extracts discussed and analyzed in the examples below, varieties such as E. citrifolium, E. havanese, E. raimondii and E. rotundifolium. For such varieties that don't have benzoylmethylecgonine and ecgonine present in the leaves, such varieties can be grown and have extracts prepared in countries such as the United States, China and Armenia.

Coca leaves, similar to grapes and tomatoes and other food sources, have a variety of tastes depending on the variety of coca plant and their soil conditions. For example, pleasant tasting coca teas can be manufactured with leaves from the Cauca region of Colombia, the Cuzco region of Peru, and the Yungas region of Bolivia. Manufacturers of the embodiments disclosed herein can choose one or more varieties of coca leaf to use in preparing extract, depending on the consumer preferences for the taste of the embodiments (for example, a diet cola with more or less of a “coca” taste). Chemicals in the extracts can also be obtained by brewing coca leaves in hot or cold water, and removing much of the water; or the coca leaves can be added to soda syrup for extended periods of time and then removed.

Coca tea has been safely consumed for over 500 years in South America (LD50 of coca tea is 3450 mg/kg—safer than vanilla and table salt). By U.S. law (21 C.F.R. 182.20), decocainized coca leaves, and their extracts, with these chemicals, are Generally Recognized As Safe for use in food products. By law (U.S. 21 C.F.R. 172.515), the FDA has approved the following chemicals (3 chemicals out of 700 in the FDA schedule) for individual use in food products: ethyl benzoate, cinnamic acid, and ethyl cinnamate. None of these chemicals are listed in the ingredient table published by the Coca-Cola Company (see: http://www.coca-colaproductfacts.com/en/coca-cola-ingredients/#glossary-C).

For some of the embodiments disclosed herein, a commercially-available liquid coca leaf extract, ERC-A20, is used which does not directly exploit the genetic resources of the coca plant. ERC-A20 is manufactured and distributed by ENACO (www.enaco.com.pe), the Peruvian government agency responsible for the industrialization of coca leaf products in the country. The extract is available in liquid form (e.g. in a one kilogram bottle of the liquid extract), and in powdered form which can also be used in the products and methods disclosed herein. Equivalents of the extract can be made by removing the water from coca tea brews, with (un)desired alkaloids removed via ion-exchange filters. Typically, coca leaves from different regions of Peru are picked and dried in the field, before being shipped to Lima. The leaves are bagged at ENACO facilities in Lima, and a container of coca leaf bags loaded for shipment from Callao (the port of Lima) to the United States. A typical bag of coca weighs about 0.8 grams. About 17 average-sized coca leaves weigh about 1.0 grams. Thus a typical bag of coca tea can contain about 13 to 14 leaves.

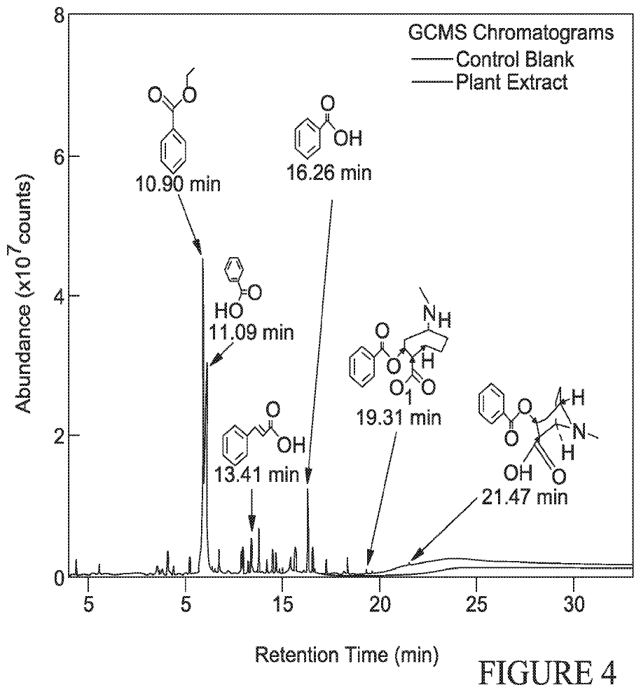

FIG. 4 is a GCMS analysis of the liquid form of the ERC-A20 coca leaf extract. One milliliter of ERC-A20 was mixed with one milliliter of dicholoromethane (DCM), with the DCM layer injected into the GCMS system for analysis. The main peaks, some identified by their retention times (RT), are as follows: 10.90—ethyl benzoate (an ester with a fruity aroma used in perfumes); 10.90 and 11.09—benzoic acid and its ester; 12.90 and 12.99—trans-cinnamic acid (has a honey-like aroma found in cinnamon oil) and ethyl cinnamate (an ester with a fruity aroma found in cinnamon oil); 13.41—an isomer of trans-cinnamic acid; 13.795—an isomer of ethyl cinnamate; 14.799—ethyl vanillate; and 16.26—isomer of 3,4,5-trimethoxybenzoic acid (also known as eudesmic acid, found in olive oil and eucalyptus oil). Any variety of coca leaf that has similar amounts of these chemicals can be used to prepare extracts that can be used whenever the ERC-A20 extract is used in embodiments disclosed herein. Conversely, varieties of coca leaves known to be less pleasant to drink (such as the coca leaves from the Chapare region of Bolivia) and thus less useful in the embodiments disclosed herein, can be treated with these chemicals to make them more pleasant to drink.

In some embodiments disclosed herein, the coca leaf extract can comprise one or more chemicals that can be found in coca leaves, selected from the group comprising: ethyl benzoate, trans-cinnamic acid, ethyl cinnamate (and cinnamon-family chemicals with similar tastes and aromas such as cinnamaldehyde), and ethyl vanillate. Depending on the legal jurisdiction, coca alkaloids and related chemicals, such as benzoylmethylecgonine, ecgonine, methylecgonine cinnamate (cinnamoylcocaine), cuscohygrine, hygrine, 3,4,5-trimethoxybenzoic acid, and benzoylecgonine, can be used in the embodiments disclosed herein that use coca leaf extracts or their equivalents.

In some embodiments, the coca leaf extract can comprise one or more of the chemicals which were detected in smaller quantities in the GCMS analysis of FIG. 4: benzoyl alcohol, benzoic acid, caffeic acid dimethyl ester, ethyl benzoate, ethyl phenylacetate, ethyl vanillate, hexanoic acid, hexenoic acid, isovaleric acid (also known as 3-methylbutanoic acid), maltol, and vanillin. In some embodiments, the coca leaf extracts can comprise one or more of other chemicals reported to be present in coca leaves, tea brews and extracts, which include: dihydrocuscohygrine, hydroxytropacocaine, tropacocaine, methyl benzoate, methyl cinnamate, cinnamic acid, truxilline, and truxillic acid.

While coca leaf extracts can be used as a natural source of one or more of these chemicals (and/or their analogs), the equivalents of coca leaf extracts can also be prepared from synthetic sources for the above, and related, chemicals. For example, a foundation for a synthetic extract can be a combination of any of the chemicals of the main peaks of FIG. 4: ethyl benzoate, benzoic acid, trans-cinnamic acid, ethyl cinnamate, ethyl vanillate, and eudesmic acid. Such a synthetic extract can additionally comprise chemicals with similar taste and aroma properties. For example, cinnamaldehyde can supplement, or be an alternative, to ethyl cinnamate.

### Exemplary Embodiment #12

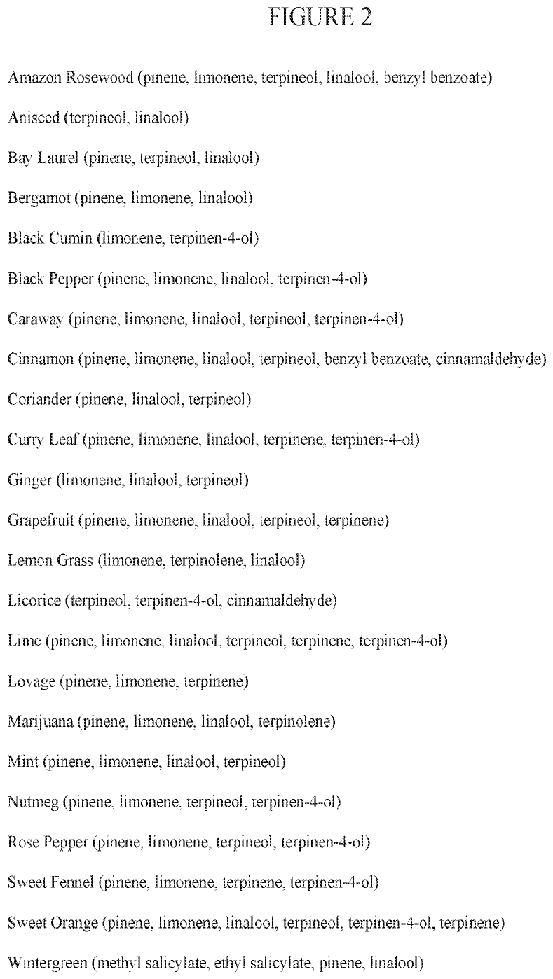

Another embodiment disclosed herein comprises use of extracts and oils of the fragrant flowers and other parts of the ylang-ylang tree (e.g., Cananga odorata), a tree of tropical Asia. Ylang-ylang oil is popular in the field of aromatherapy, used in products such as massage oils, moisturizing creams, perfumes and scented candles; ylang-ylang is also used as a traditional medicine, for example, to treat stomach ailments, asthma, hair growth, and rheumatism—and more recently its antibiotic potential has been explored. Some ylang-ylang oil and extracts contain some chemicals present in cola sodas: the monoterpenes (limonene, alpha-terpineol, linalool, etc.), and from the cinnamon and vanilla families (cinnamyl acetate, cinnamyl alcohol, vanillin). These oils and extracts also contain chemicals found in some coca leaf extracts (ethyl benzoate, methyl benzoate—which are absent from the essential oils listed in FIG. 2, essential oils most of which have never been used in cola sodas).

For the following embodiment, “Ylang-Ylang #3 Essential Oil—100% Pure Therapuetic Grade”, sold by Nature's Oil, is used. To some, this form of the oil has a strong “spicy new-tennis-ball” aroma. 7.5 ounces of Diet Coke (about 220 grams—about 222 milliliters) is poured into a glass container. One small drop of the oil is added to the Diet Coke. While it creates a different taste, and with a few drops of artificial sweetener, a more pleasant taste, the result is not a beverage that has the taste and/or aroma of a sugary Coca-Cola. However, the formulation can be the basis for a sugar-free ylang-ylang soda. Thus, while having chemicals in common with cola sodas and coca leaf extracts (see “Traditional uses, phytochemistry, and bioactivities of Cananga odorata—Ylang-Ylang”, Loh Teng Hem Tan et al., Evidence-Based Complementary and Alternative Medicines, Volume 2015, Article ID 896314), the chemical combinations in ylang-ylang oil and extracts have too many flavor and aroma chemicals to be useful for improving the taste and/or aroma of diet sodas. While a less concentrated ylang-ylang oil or extract, with some chemicals filtered out, might be used to improve the taste of diet cola sodas, it usually costs less to just use coca leaf extracts.

### Using Extracts of The Entire Coca Leaf

In countries where coca tea is not allowed by law to be sold at retail businesses, de-cocainized coca leaf extracts are used in some of the embodiments disclosed herein (and can be used anywhere in the world where Coca-Cola soda is sold). In addition, for countries such as Colombia, Peru and Bolivia, where coca tea is sold in retail establishments (or in countries such as Spain and Portugal, which have decriminalized all drugs, and thus can be amenable to products such as coca tea), coca leaf extracts with the coca alkaloid can be used with the embodiments of diet sodas disclosed herein.

### Additional Exemplary Disclosure

Mixtures of coca leaf extract and diet sodas can also be achieved by an infusion process to prepare the extract, for example, placing one bag of coca tea in 7.5 ounces of diet soda, and removing the bag after 30 minutes to a few hours or more (coca tea is typically brewed in hot water for 3 to 5 minutes). Equivalently, one can dehydrate a cup of coca tea, and then add the resulting coca tea extract powder to the 7.5 ounces of diet cola. A bag of coca tea can have the equivalent of ten coca leaves, and approximately 17 coca leaves can weigh about one gram.

Coca leaf extracts can be manufactured that have pH levels between 5 (more acidic) and 7 (less acidic). Manufacturers of the embodiments disclosed herein can choose any level for the acidity of the coca leaf extract used in the embodiments disclosed herein, depending on the desired design goal for the taste of these embodiments. Diet Coke has a pH of about 3.4, far more acidic than most coca leaf extracts. Since the coca leaf extracts are used in small quantities, their acidity level barely changes the acidity of the diet beverage.

For some of the embodiments disclosed herein, mixtures of coca leaf extracts and diet cola beverages (and their syrups) can improve the taste and/or aroma of any of a variety of formulations of diet colas of the type available circa the year 2017, such as Diet Coke, Coca-Cola Zero, Coca-Cola Light and Pepsi Light (many of which use aspartame and/or acesulfame).

### Concentrations of Chemical Components of Coca Leaf Extracts and Cola Sodas

In a subsequent GCMS analysis of the liquid form of ERC-A20 coca leaf extract, the concentrations of the main peaks of FIG. 4 were determined. Reference solutions in methanol (at 5 micrograms/milliliter) were prepared for ethyl benzoate and ethyl cinnamate. A reference solution was prepared for 1,4-dichlorobenzene at 5 micrograms/milliliter in dichloromethane, which was used for calibration purposes. For ethyl benzoate, its concentration as determined by GCMS analysis in the sample of the ERC-A20 is approximately 12 micrograms per milliliter (12.13). For ethyl cinnamate, its concentration as determined by GCMS analysis in the sample of the ERC-A20 is approximately 1.4 micrograms per milliliter (1.438).

ERC-A20 coca leaf extract in liquid form has a dark brown color. A QTOF-LCMS analysis of a sample of the extract detected the presence of caffeic acid and its isomers, as well as chlorogenic acids and their isomers (an important constituent of coffee, chlorogenic acid, also known as a caffeoylquinic acid—CQA—is the ester form of caffeic acid). Research such as Ohiopehai's in the 1980s, suggest, without much evidence, that CQAs might have an astringent and/or metallic taste. But it is mostly inconclusive if CQAs have much of an impact on the taste of coffee, and thus, on the taste of this coca leaf extract.

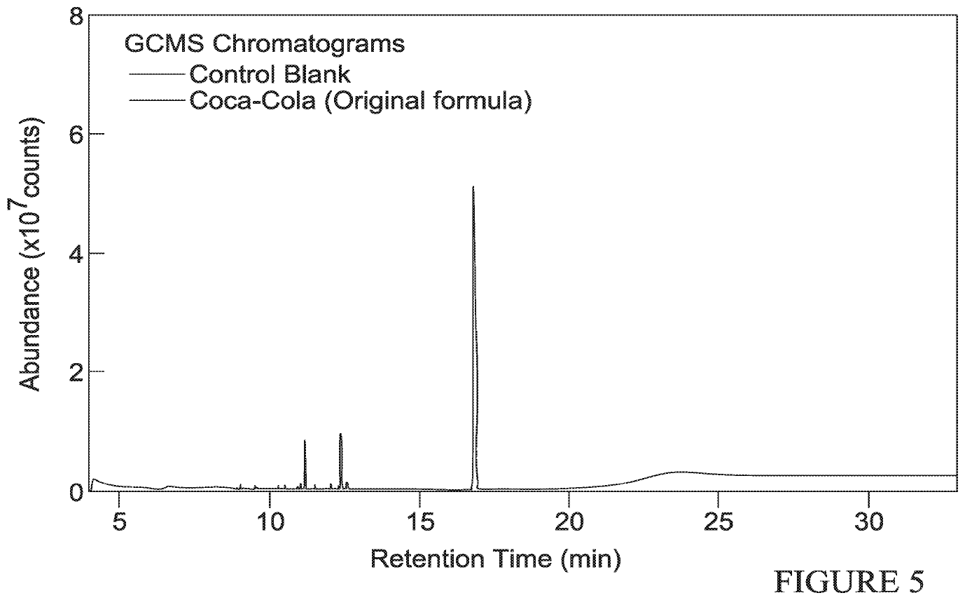

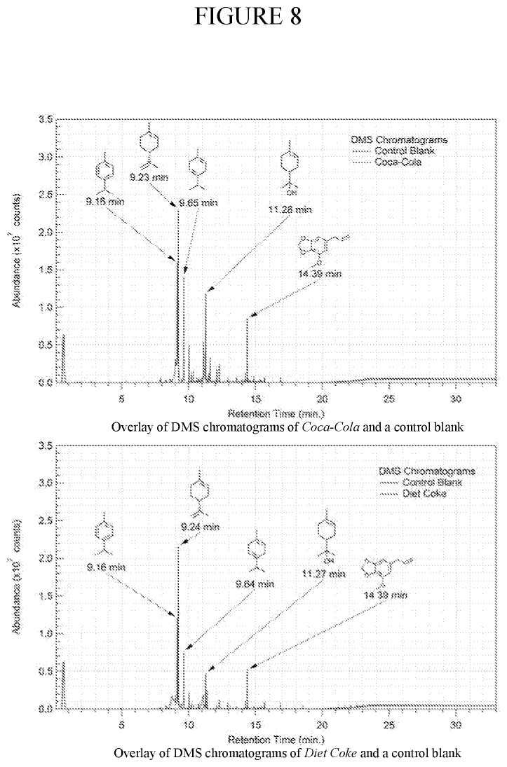

FIG. 5 depicts the results of a gas chromatography mass spectrometry (GC-MS) analysis of Coca-Cola soda. The peak at a retention time of 16.86 is caffeine, the peak at retention time of 12.39 is probably a combination of terpin and terpine-4-ol, and the peak at retention time of 11.21 is alpha-terpineol. FIG. 8 depicts the results of desorption gas chromatography mass spectrometry of Coca-Cola and Diet Coke sodas, using Stir Bar Sorptive Extraction. The peak at retention time 9.16 corresponds to cymene, the peak at 9.23/9.24 corresponds to limonene, the peak at 9.64/9.65 corresponds to gamma-terpinene, the peak at 11.27/11.28 corresponds to alpha-terpineol and the peak at 14.39 most likely corresponds to myristicin. Note: GC-MS analyses of cola sodas is complicated by the high levels of sugar, phosphoric acid and products (such as caramelan) and volatile by-products (such as diacetyl) of caramelization. GC-MS results are probably not exact, here used more for relative comparison. No peak for phosphoric acid, as explained by the GC-MS laboratory used, is probably due to phosphoric acid eluting in void, and is also not likely to ionize due to its natural acidity.

In the laboratory report in which FIG. 4 first appeared, it is reported that the chemicals detected in “abundance” in the coca-leaf extract are: ethyl benzoate, benzoic acid and its ester; and 3,4,5-trimethoxybenzoic acid (eudesmic acid). Chemicals detected in “lower abundance”: compounds consistent with: ethyl cinnamate, and trans-cinnamic acid and its isomer.

In the laboratory report in which FIG. 5 first appeared, it is reported that the chemicals detected in “abundance” in the sample of Coca-Cola are: caffeine, terpin, terpine-4-ol, alpha-terpineol. Chemicals detected in “lower abundance”: compounds consistent with o-cymene, cinnamaldehyde, and fenchol. Cymene and alpha-terpineol are also seen in FIG. 8, along with limonene, gamma terpinene and myristicin.

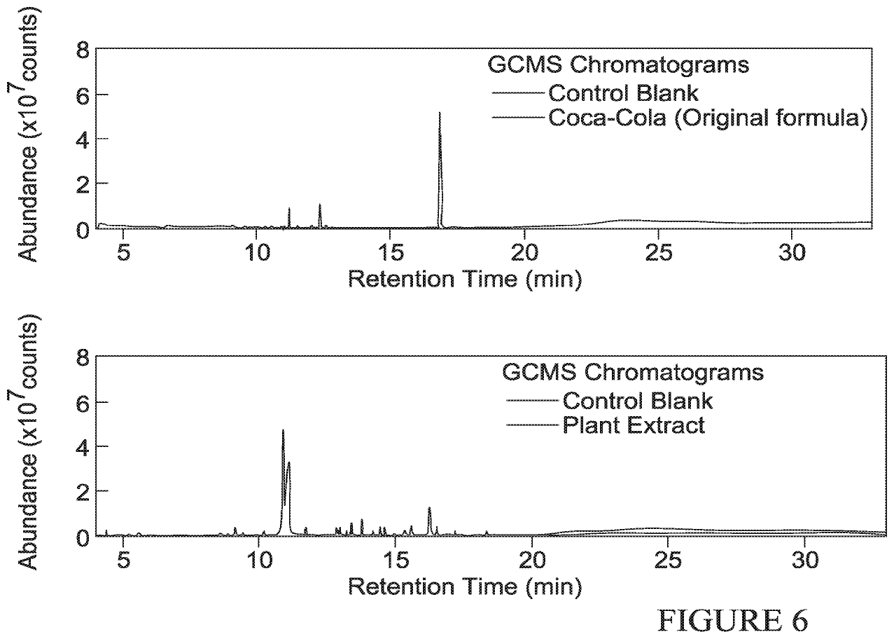

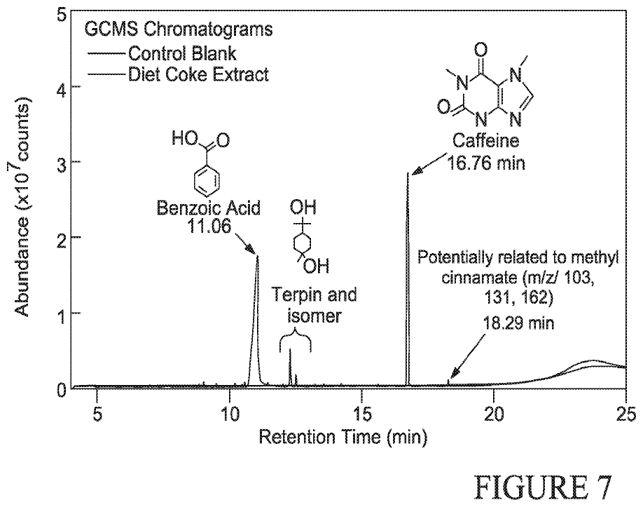

The lack of overlap of the main peaks of FIG. 5 (and FIG. 7) with the main peaks of FIG. 4 (a GCMS analysis of coca leaf extract—see comparison of FIGS. 4 and 5 in FIG. 6), indicates that Coca-Cola is not using extracts of the coca leaf in its cola sodas, at least, Coca-Cola is not using extracts of coca leaves of the variety used by ENACO to produce its ERC-A20 extract. Coca-Cola's supplier of de-cocainized coca leaves, the Stepan Company, buys the majority of its leaves from ENACO. Pepsi has never made use of extracts of the coca leaf.

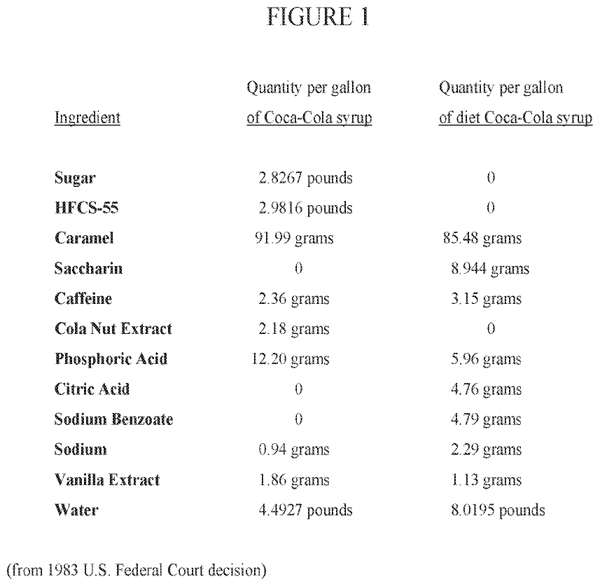

FIG. 7 depicts the results of a gas chromatography mass spectrometry (GC-MS) analysis of the Diet Coke soda (a similar analysis appears in the bottom graph of FIG. 8). The peak at a retention time of 16.76 is caffeine (very much similar to the main peak of FIG. 5 for Coca-Cola soda), and the peak at retention time of 12.39 is probably a combination of terpin and terpine-4-ol (again similar to 12.39 peak of FIG. 5). FIG. 7 also has a small peak at 18.29, mostly likely a cinnamate, again similar to FIG. 5. That is both Coke and Diet Coke are mostly sugar and caffeine, with very small amounts of flavoring (the terpenes and cinnamates, and cymene and limonene). The only significant difference between Coca-Cola and Diet Coke is the peak at 11.06—benzoic acid, a breakdown product of a preservative (currently potassium benzoate, was sodium benzoate) used in the less-acidic Diet Coke (Diet Coke uses less phosphoric acid, and uses some citric acid, to deal with aftertastes, which decreases the pH of Diet Coke—creating a need for a preservative). This similar chemical composition is consistent with the formulation data in FIG. 1, that is, if you start with Coca-Cola soda and remove all of the sugar and some of the phosphoric acid, and then add an artificial sweetener and sodium/potassium benzoate, you end up with Diet Coke.

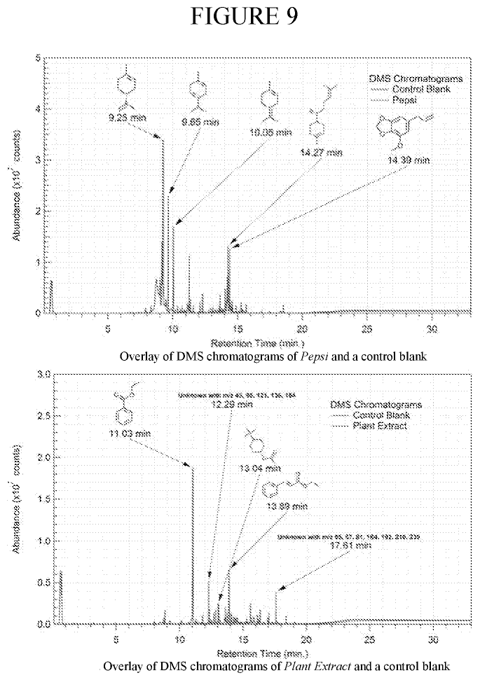

FIG. 9 depicts the results of desorption gas chromatography mass spectrometry of Pepsi cola soda and coca leaf extracts, using Stir Bar Sorptive Extraction. Given the similarities in taste and aroma of Coca-Cola and Pepsi cola sodas, it is no surprise that Pepsi shares with Coca-Cola some of the same flavoring chemicals—limonene at a retention time of 9.25 and gamma-terpinene at a retention time of 9.65 (which are more dominant in Pepsi cola soda). And much like Coca-Cola sodas, there is a lack of overlap between the chromatograms of Pepsi soda and coca leaf extracts, which is consistent with the fact that PepsiCo has never used the coca leaf in its cola sodas, despite the fact that it can easily obtain coca leaf extracts with one telephone call to ENACO in Peru.

### Exemplary Embodiment #13

A water-based solution of alpha-terpineol was prepared, where the concentration of alpha-terpineol was 48 micrograms/milliliter. Alpha-terpineol is a monoterpene alcohol found in both Coca-Cola and Diet Coke at similar concentration, and is said to have a weak, pleasant odor similar to lilac. About one teaspoon of this alpha-terpineol solution is added to 220 milliliters of Diet Coke. While there is not much in the way of a change in the taste and/aroma of the Diet Coke, the experience of drinking this modified Diet Coke is more pleasant. Similarly, one half of a teaspoon of gamma-terpinene (also a flavoring component of current cola sodas, with a pine oil smell), with a concentration of 40 micrograms/milliliter, is added to 220 milliliters of Diet Coke. The resulting Diet Coke, while more pleasant as seen with adding alpha-terpineol, also has less of a “coca cola” taste. In contrast, one teaspoon of linalool (which has a more pleasant aroma than many terpinenes)—also a component of cola sodas—also with a concentration of 40 micrograms per milliliter, is added to 220 milliliters of Diet Coke. There is little-to-no change in the unpleasant.

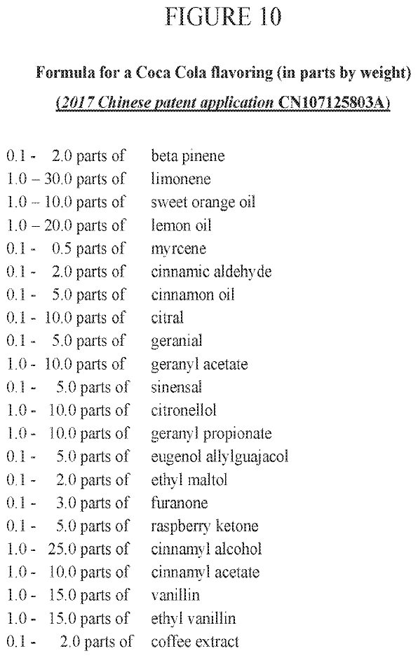

These Embodiments suggest that the taste and/or aroma of existing diet cola sodas can be improved by increasing some of the flavoring chemicals already in such sodas, such as increasing the amount of alpha-terpineol. This may follow from FIG. 8, which has GC/MS spectra of Coke and Diet Coke. While one cannot absolutely compare two GC/MS spectra, the control peaks in both graphs has similar intensities to the extent that relative comparisons can be made. One such relative comparison is that Coke soda appears to have slightly higher concentrations of the main flavoring chemicals than Diet Coke. Other possible chemicals and or essential oils that can be similarly used appear in FIG. 10, a coca-cola flavoring for electronic cigarettes disclosed in Chinese Patent Application CN107125803A, titled “Electronic cigarette tar and preparation method thereof”.

### Synthetic Extracts

Clear, liquid solutions are prepared for ethyl benzoate and methyl benzoate, for example, at a concentration of 24 micrograms/milliliter in a liquid such as water. Ethyl benzoate, a colorless clear liquid, is the ester formed by the condensation of benzoic acid and ethanol. It has a pleasant odor, is a component of a few fragrances (e.g., under the name Essence de Niobe), for its aroma and preservative properties. Ethyl benzoate is mostly insoluble in water—the solubility of ethyl benzoate in water is 500 micrograms/milliliter. Related benzoates may be used, for example propyl benzoate (nutty odor with sweet fruit taste, used as preservative in cosmetics), benzyl benzoate (weak, sweet, balsamic odor, used to as a fixative in perfumes), and phenethyl benzoate (slight rose scent—used in cosmetics).

The presence of ethyl benzoate and other ester benzoates in the embodiments disclosed herein can be objectively tested for by using techniques such as GC-MS, that is, one can differentiate cola sodas with regards to their use of the claimed compositions disclosed herein by using GC-MS techniques or by using spike analysis, useful for detecting infringement of the methods disclosed herein. For companies such as Coca-Cola and PepsiCo that apparently can't afford to purchase GC/MS chromatography machines, commercial laboratories can perform such testing for a few thousand dollars or so.

### Exemplary Embodiment #12

In a variant of Exemplary Embodiment #1, about 5 milliliters (one teaspoon) of a liquid (e.g., water) solution that has about 24 micrograms per milliliter of ethyl benzoate is used instead of one teaspoon of coca leaf extract (both of which are mixed with 7.5 ounces of Diet Coke). A taste and/or aroma more pleasant than that of untreated Diet Coke results, though with less of an improvement than can be achieved by adding coca leaf extracts. For all of the Exemplary Embodiments disclosed herein, wherever about one teaspoon of coca leaf extract is used, new embodiments can be derived by substituting about one teaspoon of a liquid solution of ethyl benzoate of a concentration of about 24 micrograms per milliliter, instead of using the coca leaf extract. The concentration and amount of ethyl benzoate varies according to taste. Using just ethyl benzoate to improve the taste of diet sodas mostly does not change the manufacturing cost. The teaspoon of ethyl benzoate solution used in the above introductory example has 100 micrograms of ethyl benzoate. 100 grams of ethyl benzoate can be purchased from Sigma-Aldrich for about 30 dollars. 100 micrograms thus costs 0.0030 cents—a negligible cost per serving of a soda beverage. In some of the embodiments disclosed herein, one to three drops (about 0.35 milligrams) of liquid saccharin (Sweet'n Low) are used per teaspoon of coca leaf extract or ethyl benzoate solution. One kilogram of sodium saccharin can be bought for $35, so those three drops cost about 0.001 cents—another negligible cost per serving of soda.

In a variant of Exemplary Embodiment #12, about 5 milliliters of a liquid (e.g., water) solution of methyl benzoate is used that has a similar concentration to about 24 micrograms per milliliter, achieving an improvement in Diet Coke taste similar to that of ethyl benzoate. While methyl benzoate can be used in the embodiments disclosed herein for commercial purposes, methyl benzoate has two known uses not completely compatible with a consumer beverage. First, methyl benzoate is one of the breakdown products of cocaine, and its odor is used by drug control drugs to detect the smuggling of cocaine—government authorities will not be keen to having diet sodas, using methyl benzoate, filling the airspaces of public places with the aroma of methyl benzoate. Second, methyl benzoate is also attractive to the males of various species of orchid bees, and is commonly used as bait to attract such bees—not a use compatible with consumer beverages.

### Using Chemicals with Similar Odors

For chemicals such as ethyl benzoate that improve the taste and/or aroma of diet sodas, alternative chemicals with similar aromas can be used. One avenue to discover such alternatives is based on the shape theory of olfaction—that the molecular size, shape and functional groups of a chemical—activating receptors in the nose—can influence the resulting aroma experienced by the brain. Manufacturers can screen organic compounds using this theory to identify other chemical useful for making more pleasant diet sodas. One such technique for discovering other chemicals (that achieve similar effects to chemicals such as ethyl benzoate in coca leaf extracts, or its ester-sibling methyl benzoate) that improve the taste and/or aroma of diet sodas is (Q)SAR analysis—(quantitative) structure/activity relationships, which statistically analyses the molecular structure and other bio-/chemical/physical/safety property data of a set of chemicals that could be related.

### Manufacturing Techniques

Existing manufacturing processes for diet cola sodas and syrups are easily modified to use the methods disclosed herein. Where mixing tanks are used to prepared the soda or syrup, an additional pipe can be attached to allow a controlled flow of (synthetic) coca leaf extract or ethyl benzoate solution, to be mixed in with other ingredients. These extracts/solutions are liquid at room temperature, and easy to transport and safely mix with mechanical equipment.

### Null Taste Control Test #1

About one teaspoon of liquid ERC-A20 coca leaf extract is added to 220 milliliters of sugary Coca-Cola (“sabor original” in Latin America). There is little-to-no change in the pleasant taste of the beverage, with the coca leaf taste and/or aroma more noticeable.

### Null Taste Control Test #2

In one experiment, a pulverized multivitamin pill (Centrum Men, typically flavorless) is added to 220 milliliters of Diet Coke. There is little-to-no change in the unpleasantness of Diet Coke. A typical multi-vitamin/multi-mineral pill (such as Centrum Men) has the usual vitamins (A, Bs, C, D, E, K, etc.) and minerals (calcium, iron, phosphorus, iodine, magnesium, zinc, potassium, etc.). The lack of appreciable change in taste and/or aroma implies that these vitamins and minerals, some also present in coca leaf extracts, are not essential to embodiments disclosed herein.

### Null Taste Control Test #3

One nutritional supplement, popular for flavoring foods, is cinnamon. In one experiment, 400 milligrams of powdered cinnamon are added to 220 milliliters of Diet Coke. No improvement in “Coca-Cola” taste and/aroma is experienced, but rather the additive taste of Diet Coke plus cinnamon. This effect has been exploited by PepsiCola with its sugary Pepsi Fire cinnamon flavored cola. The main chemical that gives cinnamon its flavor and aroma is cinnamaldehyde. Cinnamon oil contains a variety of chemicals, including cinnamaldehyde, limonene, linalool, and eugenol. Cinnamon oil, or any or all of its component chemicals, can be added to the embodiments disclosed herein.

### Null Taste Control Test #4

A tea similar in “delicious” taste to coca tea is jasmine tea, a popular green tea from SouthEast Asia, a mixture of base green tea leaves and aromatic flowers from the Jasminum sambac plant. Unlike coca tea, jasmine tea contains no alkaloids, but does contain many chemical common to all teas, including flavonoids, phenols and saponin. Some of the major taste and aroma components of jasmine tea (depending on variety and preparation) can include linalool (a terpene alcohol found in some analyses of Coca-Cola soda), benzyl acetate (which independently provides a “jasmine” aroma), hexenyl benzoate, benzyl alcohol, and methyl anthranilate (which can provide a “fruity” aroma in perfumes). (see “Changes in the volatile, chemical components and antioxidant activities of Chinese jasmine tea during the scenting process”, Meichun Chen et al., Int. J. of Food Properties, Volume 20, 2017). In one experiment, one bag of Celestial Organic “Jasmine Green” tea is brewed for two minutes in 60 milliliters of hot water, cooled to room temperature, and added to 220 milliliters of Diet Coke. No improvement in “CocaCola” taste and/or aroma is experienced, but rather the additive taste of Diet Coke plus jasmine tea.

### Null Taste Control Test #5

In one experiment, one drop (about a quarter of a smidgen, which is 1/32th of a teaspoon) of bergamot oil (“Bergamota” sold by Aromas Para El Alma, Costa Rica) is added to 220 milliliters of Diet Coke. No improvement in “Coca-Cola” taste is experienced, but rather the additive taste of Diet Coke plus bergamot oil. While bergamot oil typically can be about 50% limonene and gamma-terpinene, two cola flavoring chemicals, it is also can be about 10% by weight of pinene (a major component of pine oil, known to be an off-flavor in mango juice made from overripe mangos).

### Null Taste Control Test #6

Use of methyl benzoate in some of the embodiments disclosed herein suggests use of other methyl esters. One such other methyl ester is methyl 2-hydroxybenzoate, the methyl ester of salicylic acid (aspirin is acetylsalicylic acid), better known as wintergreen oil. Wintergreen oil has had some use in the soda industry. After the FDA banned the use of safrole in root beer (a chemical found in sassafras, a classic ingredient in root beer), the root beer industry substituted a combination of licorice root and wintergreen. In one experiment, one to two drops of wintergreen oil (Nature's Oil Organic Wintergreen Essential Oil) is added to 220 milliliters of Diet Coke. The resulting taste is dominated by the taste of wintergreen, which while being the basis for a wintergreen soda, does not seem effective in improving the “cola” taste and/or aroma of Diet Coke.

### Null Taste Control Test #7

In one experiment, 1/32^{nd} of a teaspoon of sodium benzoate (density: 1.5 g/cm³) is added to 220 milliliters of Diet Coke (a total weight of 230 milligrams, versus 100 micrograms of ethyl benzoate in some of the above embodiments). No improvement in “Coca-Cola” taste is experienced, but rather the additive taste of Diet Coke plus saltiness. Sodium benzoate doesn't have much of an odor, and a bit of an unpleasant taste. Sodium benzoate was used for decades by Coca-Cola and Pepsico only as a preservative, before being replaced with potassium benzoate (at least in the U.S.), due to health concerns of a breakdown product, benzoic acid. Similar lack of a change of taste is expected when adding potassium benzoate, as both chemicals are used interchangeably in Diet Coke and Pepsi around the world.

### Null Taste Control Test #8

In one experiment, about one teaspoon of liquid ERC-A20 coca leaf extract is added to 220 milliliters of Nite Lite Craft Light Lager (brewed and canned by Night Shift Brewing, Everett, Mass.), a lo-calorie beer (120 calories per 12 fluid ounce can). Little significant improvement in “beer” taste and/or aroma is experienced, but rather the additive taste of beer and the extract.

### Use of Maracuya as a Substitute for Ingredients in Cola Sodas

Maracuya (better known as the passion fruit), has a variety of interesting properties which can be of use when making cola beverages. First, maracuya oil/juice has a pH of about 3.0 to 3.3, close to the pH of Coca-Cola (around 2.5, while Diet Coke has a pH around 3.4) due to its use of phosphoric acid (at some concentration, it has a pH of 1.0 to 3.0). Maracuya oil/juice is by weight about 20% sugar. Some of the chemicals identified in maracuya include limonene (present in cola sodas due to the use or orange and lemon oils), hexanoates (esters of hexanoic acid, versus the hexadecanoic acids of the kola nut), and butanoates such as ethyl butanoate (which can provide a pineapple aroma). For some of the embodiments disclosed herein, a soda can be made by starting with an existing formulation for cola soda, reducing the amount of phosphoric acid, sugar and/or oil flavorings, and adding extracts of maracuya plant.

1. A diet cola beverage product with an improved taste, comprising ethyl benzoate.

2-6. (canceled)

7. The diet cola beverage product of claim 1, further comprising one or more ingredients selected from trans-cinnamic acid, ethyl cinnamate, ethyl vanillate, eudesmic acid, or a combination thereof.

8. (canceled)

9. A diet cola syrup with an improved taste, comprising:
a diet cola syrup; and
ethyl benzoate.

10-13. (canceled)

14. The diet cola syrup of claim 9, further comprising one or more ingredients selected from trans-cinnamic acid, ethyl cinnamate, ethyl vanillate, eudesmic acid, or a combination thereof.

15. (canceled)

16. A method for improving the taste of a diet cola beverage product comprising adding ethyl benzoate to the diet cola beverage product.

17. A method for improving the taste of a diet cola syrup comprising adding ethyl benzoate to the diet cola syrup.

18. (canceled)
